(19) United States
(12) Patent Application Publication
(10) Pub. No.: US 2012/0239562 A1
(43) Pub. Date: Sep. 20, 2012

(54) APPARATUS, METHOD, AND SYSTEM FOR TRACKING HYBRID SAVINGS

(76) Inventor: Jean-Patrick V. Rich, Nashville, IN (US)

(21) Appl. No.: 13/423,880

(22) Filed: Mar. 19, 2012

Related U.S. Application Data
(60) Provisional application No. 61/454,329, filed on Mar. 18, 2011.

(51) Int. Cl. G06Q 20/22

(52) U.S. Cl. 705/40

(57) ABSTRACT

A vehicle includes a hybrid powertrain and a controller. The controller includes a processing device that is operatively coupled to a transmitter, a receiver, and the hybrid powertrain. The processing device is structured to monitor the hybrid powertrain, to calculate information corresponding to powertrain energy usage, and to transmit the information to a computer.

### CROSS-REFERENCE TO RELATED APPLICATIONS

This application claims the benefit of the filing date of Provisional Application No. 61/454,329 filed on Mar. 18, 2011, which is incorporated herein by reference.

### BACKGROUND

The present invention generally relates to a savings tracking system, and more particularly, but not exclusively, relates to a hybrid savings tracking system, apparatus and method.

Today some vehicles include a hybrid powertrain. Some existing hybrid systems and methods have various shortcomings relative to certain applications. Accordingly, there remains a need for further contributions in this area of technology.

### SUMMARY

One embodiment of the present application is a unique hybrid savings tracking system. Other embodiments include apparatuses, systems, devices, hardware, methods, and combinations for tracking hybrid savings. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views.

FIG. 1 is a schematic diagram of a system including a vehicle and a computing device.

FIG. 2 is a schematic diagram of a device.

FIG. 3 is a schematic diagram of various types of powertrain energy usage information.

FIG. 4 is a schematic diagram of an invoice.

FIG. 5 is a schematic flow diagram for tracking hybrid savings.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

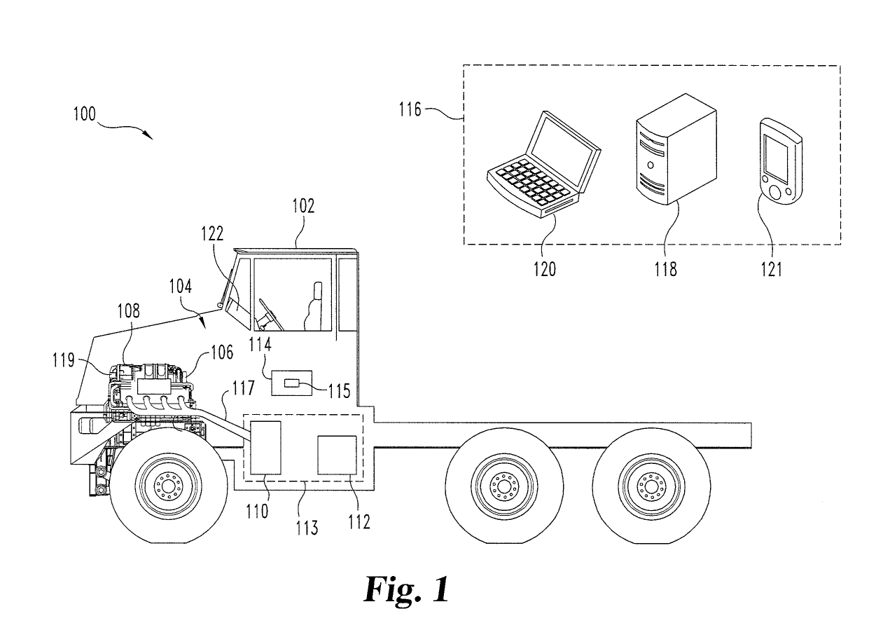

FIG. 1 is a schematic diagram of a system 100 including a vehicle 102. The vehicle 102 includes a hybrid powertrain 104 and a controller 106. The hybrid powertrain 104 includes an internal combustion engine 108, one or more electric power generators 110, one or more electrically-powered traction motors 112, and an electrical energy storage device 114. The controller 106 is operatively coupled to the hybrid powertrain 104. The vehicle 102 may be any vehicle that utilizes an internal combustion engine including, but not limited to, locomotives, aircraft, trucks, and automobiles. The engine 108 may be any type of internal combustion engine such as diesel, gasoline, natural gas, gas turbine, microturbine, spark ignition, compression ignition, or any other type of engine or power plant. In the form of a reciprocating engine, the engine 108 may include one or more cylinders (not shown).

The energy storage device 114 may include one or more electrochemical cells 115 and may be configured as a battery pack. The energy storage device stores energy generated by the one or more generators 110, such as when the engine 108 drives the generator 110 or during regenerative braking. The energy storage device 114 may also provide power to the one or more motors 112, which may be used to propel the vehicle 102. The vehicle 102 may include an alternator 119, which may provide power to charge a standard battery to start the vehicle 102, and/or to provide electrical power to one or more accessories. Alternatively, generator 110 and/or cells 115 may be used to provide electric power to certain accessories and/or start the vehicle 102.

In one embodiment, at least one of the generators 110 and one of the motors 112 are provided in the form of a motor/generator 113. In one particular implementation, only one such motor/generator is all that is included, such that there are not multiple generators 110 and/or motors 112. Furthermore, the motor/generator 113 may be selectively coupled to a mechanical power output shaft 117 of the internal combustion engine 108 using, for example, a clutch (not shown).

System 100 also includes a computing device 116 structured to communicate with the controller 106. The computing device 106 may be, e.g., a server 118 or a computer 120, which may be a handheld device 121. The computer 120 may be one that is used during a service event by a technician to acquire data from the controller 106. The computer 120 may be communicate with the controller 106 wirelessly or by a wired connection. The vehicle 102 may include a display 122, such as a LCD, for displaying the information corresponding to powertrain energy usage, fuel consumption, or the like.

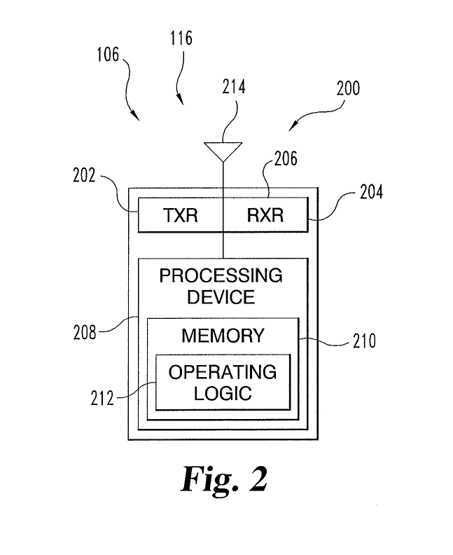

Referring additionally to FIG. 2, further details of a device 200, such as controller 106 or computing device 116, are depicted. Device 200 includes a transmitter (TXR) 202 and a receiver (RXR) 204 integrated to define a transceiver 206. In other embodiments, transmitter 202 and receiver 204 may be separate from one another. Device 200 further includes a processing device 208 in operative communication with transceiver 206. Processing device 208 includes memory 210. Memory 210 may store information regarding powertrain energy usage. Furthermore, processing device 208 executes operating logic 212, which may be stored in memory 210, to perform various routines with device 200, including those further described as follows.

Additionally or alternatively, device 200 may include an interface to provide a hard-wired, cable communication connection. In one embodiment, transceiver 206 sends communication signals to and receives communication signals from antenna 214, and communicates with processing device 208 to provide desired encoding of information/data in the signals, as might be desired for various applications of system 100.

Processing device 208 includes appropriate signal conditioners to transmit and receive desired information (data), and correspondingly may include filters, amplifiers, limiters, modulators, demodulators, CODECs, signal format converters (such as analog-to-digital and digital-to-analog converters), clamps, power supplies, power converters, and the like as needed to perform various control, communication, and regulation operations described herein. Processing device 208 can be comprised of one or more components of any type suitable to process the signals received from transceiver 206 or elsewhere, and provide desired output signals. Such components may include digital circuitry, analog circuitry, or a combination of both. Processing device 208 can be of a programmable type; a dedicated, hardwired state machine; or a combination of these; and can further include multiple processors, Arithmetic-Logic Units (ALUs), Central Processing Units (CPUs), or the like. For forms of processing device 208 with multiple processing units, distributed, pipelined, and/or parallel processing can be utilized as appropriate. Processing device 208 may be dedicated to performance of just the operations described herein or may be utilized in one or more additional applications. In the depicted form, processing device 208 is of a programmable variety that executes algorithms and processes data (e.g., information corresponding to powertrain energy usage) in accordance with operating logic 212 as defined by programming instructions stored in memory 210. Alternatively or additionally, operating logic 212 for processing device 208 is at least partially defined by hardwired logic or other hardware.

Memory 210 may be of one or more types, such as a solid-state variety, electromagnetic variety, optical variety, or a combination of these forms. Furthermore, memory 210 can be volatile, nonvolatile, or a mixture of these types, and some or all of memory 210 can be of a portable variety, such as a disk, tape, memory stick, cartridge, or the like. Memory 210 can store data that is manipulated by the operating logic 212 of processing device 208, such as data representative of signals received from and/or sent to transceiver 206 in addition to or in lieu of storing programming instructions defining operating logic 212, just to name one example.

In an aspect of the present application, a provider, such as an individual, dealer, finance company or manufacturer of the vehicle or hybrid powertrain system, provides a vehicle 102 to a customer in the form of lease or sale of the vehicle 102 to the customer. The processing device 208 of the controller 106 is structured to execute operating logic 212 to determine, receive, and/or monitor the information 124 for the hybrid powertrain 104. Memory 210 may store the information 124, which may include an amount of fuel saved, a type of hybrid powertrain, a driving route, a vehicle application, and a driver profile, among other information.

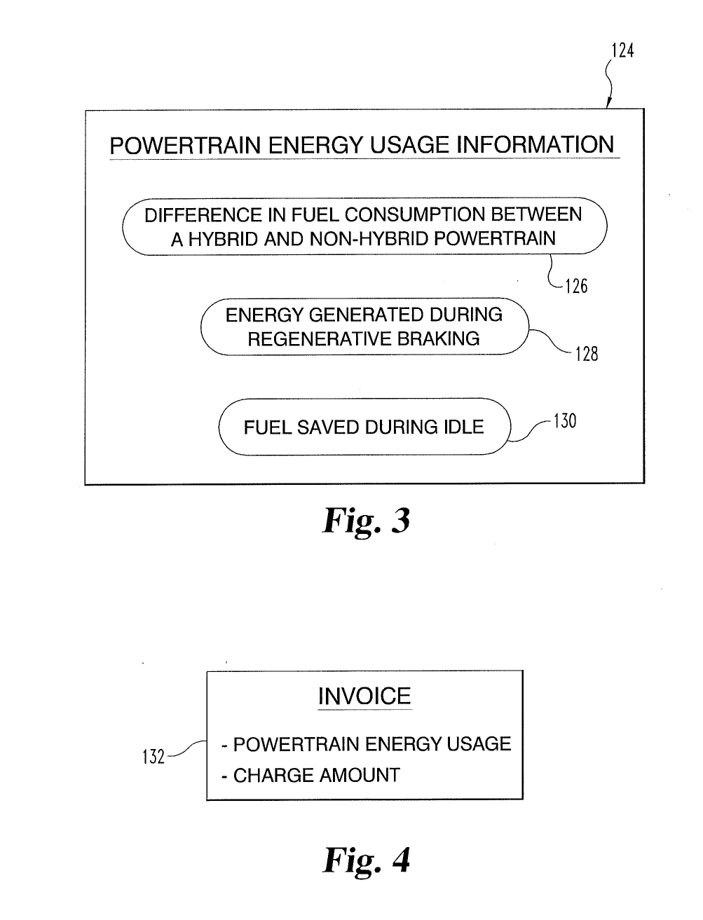

Turning to FIG. 3, the processing device 208 of the controller 106 may be structured to execute operating logic 212 to calculate information 124 corresponding to powertrain energy usage. In another embodiment, one or more computing devices 116 at the provider receive data and measurements from the controller 106, and the computing device 116 calculates the information 124 based on data and measurements from the controller 106. In one embodiment, the information 124 corresponding to powertrain energy usage may include a difference 126 between an amount of fuel used by the hybrid powertrain 104 for a power demand and an amount of fuel that would be used by a non-hybrid engine for the same power demand because generally electricity will be used to fulfill at least part of the power demand in the hybrid powertrain 104 thus saving fuel. In another embodiment, the information 124 corresponding to powertrain energy usage includes information regarding energy generated during regenerative braking 128 using the motor/generator 113 and energy storage device 114. In yet another embodiment, the information 124 corresponding to powertrain energy usage includes information regarding fuel use avoided during idle 130 because the engine 108 was able to be turned-off and the motor/generator 113 and/or energy storage device 114 was able to be used. In still other embodiments, the information 124 may include two or more of these 126, 128, 130 and/or different data regarding energy/fuel savings/usage.

The processing device 208 of the controller 106 may be structured to execute operating logic 212 to transmit the information 124 to the computing device 116. The information 124 may be transmitted to the computing device 116 in real-time, or periodically such as weekly or monthly, or during servicing events. In addition, the information may be transmitted wirelessly or by a wired connection. Alternatively or additionally, the information 124 may be sent when the vehicle 102 is parked in the vehicle's normal parking/garage address via equipment provided to the user for installation there or using an Internet connection at the vehicle's parking location.

The computing device 116 receives information 124 corresponding to powertrain energy usage from the controller 106. As a function of the information 124, the customer may be charged for use of the vehicle 102 in a manner that is correlated to the fuel savings. In one embodiment, the providing of the vehicle 102 to the customer includes leasing or selling the vehicle 102 to the customer. In one particular implementation, there is a base lease amount and a variable periodic lease payment portion that is determined as a function of energy/fuel savings. In another embodiment, the vehicle 102 is sold to the customer at a subsidized price and the customer is charged a variable periodic payment to amortize the remaining portion of the sales price as a function of energy/fuel savings.

In FIG. 4, the amount of money to be charged and the powertrain energy usage information, among other things, may be reported to the customer in the form of an invoice 132. In one embodiment, the invoice 132 is electronically transmitted, such as by email, to the customer. In another embodiment, the invoice is mailed to the customer.

The computing device 116, such as server 118 or computer 120, of the provider may execute operating logic 212 to receive the information 124 from the processing device 208 and to make one or more determinations. For example, as a function of the information 124, the amount of money charged may be increased if the information 124 indicates a less than expected powertrain energy usage. Furthermore, as a function of the information, the amount of money charged may be decreased if the information indicates a greater than expected powertrain energy usage. As a function of the information, the number of payments may be increased if the information indicates a less than expected powertrain energy usage. In addition, as a function of the information, the number of payments may be decreased if the information indicates a greater than expected powertrain energy usage.

In another embodiment, a customer is provided with a lease option that is tied to calculating the actual amount of fuel savings attributed to the hybrid powertrain 104 when in use. The lease could be structured to offer a lower initial investment, in conjunction with a regular lease payment. The regular lease payments are tied to the specific (actual) amount of fuel that was saved for the particular customer (vehicle, route(s), driver(s), etc). By measuring and recording the amount of torque or power that is produced via the electric motor/generator 113, the equivalent amount of fuel can be calculated that would have had to be consumed to create the equivalent power. This calculation measures the amount of fuel that was saved due to the hybrid powertrain 104.

The controller 106 is structured to perform real-time measurements, storage, and reporting of the amount of fuel saved or other information 124 in a vehicle 102 having a hybrid powertrain 104. Other data may include, but is not limited to, the type of hybrid powertrain, vehicle application, route, and driver. This information 124 may be used to structure tailored lease and other periodic payment programs that reduce the customers risk by lowering initial investment and by tying at least a portion of periodic customer payments directly to the actual amount of fuel savings that is realized in a specified time period.

In another aspect of the present application, a fuel savings or a powertrain energy usage calculator may include a model of a conventional powertrain, and mechanisms to track actual fuel usage of the hybrid powertrain 104. Vehicle power demand may be determined using vehicle speed and throttle position. A model can be used to estimate conventional engine fuel consumption based on vehicle power demand. Fuel use in the hybrid powertrain 104 can be calculated by tracking the fuel used by the engine 108. The difference 126 would be fuel saved. Alternatively or additionally, fuel savings or powertrain energy usage could be calculated based on energy stored in the battery during regenerative braking 128, and fuel use avoided at idle 130. In still other embodiments, a different model based on a combination of these and/or other energy usage/savings data could be utilized.

In another aspect of the present application, fuel savings or powertrain energy usage may be tracked over time and reported out during service events. During a service event, a technician will use a computer 120 or handheld tool 121 to communicate, e.g., using datalinks, to examine stored data in the electronic control module (ECM), such as controller 106. The same procedure could be used to report fuel savings or powertrain energy usage. The service technician would then report the fuel savings to the provider of the vehicle 102 and to the customer. In another embodiment, a wireless communication device, such as controller 106 or computer 120, could periodically report fuel savings to the provider and to the customer, which could be from any location designed by the user of the system 100. By using a wireless communication device, the customer could check the fuel savings or powertrain energy usage at any time. In yet another embodiment, a display 122 could show the operator of the vehicle 102 the fuel savings or powertrain energy usage in real-time. The display 122 could also be used by, e.g., a vehicle distributor or service technician, to confirm fuel savings or powertrain energy usage.

A lease or payment arrangement could be structured in a variety of ways. In one embodiment, all or a portion of the initial capital outlay for the vehicle and/or hybrid powertrain system are financed through lease or other payments that vary based on actual fuel saved through operation of the hybrid powertrain system. If fuel savings did not meet expectations, then the lease or other payments for the vehicle and/or the hybrid powertrain system would be lower or spread over a longer time period. If fuel savings exceeded expectations, the payments would be higher or spread over shorter time periods and the deferred capital would be paid off sooner. In this way, some of the risk associated with hybrid vehicle performance not being sufficient to justify higher initial capital outlays would be shared with the provider. As used herein a provider can be a manufacturer of the vehicle, a manufacturer of the hybrid powertrain system, a dealer, a finance company, or an individual, for example.

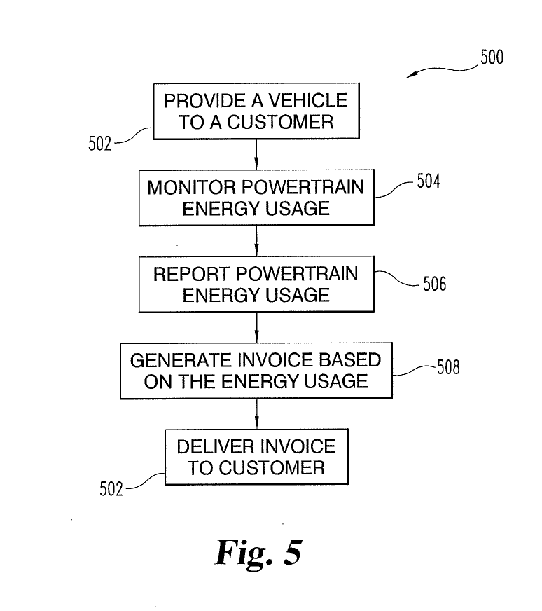

The schematic flow diagram in FIG. 5, and the related descriptions which follow, are illustrative embodiments of a technique 500 for tracking hybrid savings. Operations illustrated are understood to be exemplary only, and operations may be combined or divided, and added or removed, as well as re-ordered in whole or in part, unless explicitly stated to the contrary. The technique 500 may be implemented by one or more computers executing one or more computer programs stored on a computer readable storage medium. The computer program comprises instructions or operating logic causing the computer to execute one or more of the operations of the technique 500.

In operation 502, a provider provides a vehicle 102, including a hybrid powertrain 104, to a customer. In one embodiment, the vehicle 102 is provided through a leasing arrangement. In operation 504, a controller 106 may monitor and record energy usage, such as information 124, in the hybrid powertrain 104 using various sensors and circuitry as described above. In operation 506, the controller 106 reports or transmits the powertrain energy usage information 124 to one or more computing devices 116 and/or display 122. The reporting may occur during a servicing event at predetermined times or locations, or continuously or at any other time. In operation 508, the computing device 116 generates an invoice 132 based on the powertrain energy information 124. Moreover, the amount of money charged or the number of payments vary based on the energy/fuel usage. In operation 510, the invoice 132 is delivered to the customer via any suitable means, such as an email or postal service.

The present application may provide one or more of the following features. For example, barriers to entry in the hybrid vehicle market will be lowered for those customers that would like to utilize hybrids. Generally, it will be easier for customers to enter the market since initial capital outlays can be reduced and risks of hybrid fuel savings not meeting expectations is shared by the provider and customer. The customers' payment is a function of the actual fuel savings or powertrain energy usage and not a hypothetical calculation that may or may not match a unique usage situation. In addition, providers are incentivized to maximize fuel savings to increase and/or accelerate lease payments from the customer.

In one aspect of the present application, a method, comprises: providing a vehicle to a customer, the vehicle including a hybrid powertrain operatively coupled to a controller, the hybrid powertrain including an internal combustion engine, one or more electric power generators, one or more electrically-powered traction motors, and an electrical energy storage device; receiving information corresponding to hybrid powertrain energy usage from the controller; and varying, as a function of the hybrid powertrain energy usage, an amount of a periodic payment to be made by the customer for the vehicle.

Features of the aspect of the present application may include: wherein at least one of the generators and at least one of the motors are provided in the form of a motor/generator; wherein the motor/generator is selectively coupled to a mechanical power output shaft of the engine; wherein the vehicle includes an alternator; wherein the energy storage device includes a plurality of electrochemical cells; wherein providing the vehicle to the customer includes leasing the vehicle to the customer; wherein the information includes a difference between an amount of fuel used by the hybrid powertrain for a power demand and an amount of fuel that would be used by a non-hybrid engine for the power demand; wherein the information includes information regarding energy generated during regenerative braking; wherein the information includes information regarding fuel use avoided during idle; wherein the information is received by a provider of the vehicle wirelessly from the controller; receiving the information during a service event and the information is received by a provider of the vehicle; displaying the information in the vehicle to an operator of the vehicle; reporting the amount of the periodic payment to the customer; wherein reporting the amount of the periodic payment includes at least one of electronically transmitting an invoice to the customer and mailing an invoice to the customer; increasing the amount of the periodic payment if actual hybrid powertrain energy usage is less than an expected powertrain energy usage; decreasing the amount of the periodic payment if actual hybrid powertrain energy usage is greater than an expected powertrain energy usage; increasing a number of payments if actual hybrid powertrain energy usage is less than an expected powertrain energy usage; decreasing a number of payments if actual hybrid powertrain energy usage is greater than an expected powertrain energy usage.

In another aspect of the present application, an apparatus, comprises: a hybrid powertrain for a vehicle; a transmitter; a receiver; and a processing device operatively coupled to the transmitter, the receiver, and the hybrid powertrain, the processing device being structured to execute operating logic to monitor the hybrid powertrain, to calculate information corresponding to hybrid powertrain energy usage for use in determining a periodic payment for the vehicle, and to transmit the information to a computing device.

Features of the aspect of the present application may include: wherein the processing device transmits the information to the computing device in real-time; wherein the computing device is structured to execute operating logic to receive the information corresponding to hybrid powertrain energy usage from the processing device and vary a lease payment as a function of the hybrid powertrain energy usage; means for storing at least one of an amount of fuel saved, a type of hybrid powertrain, a driving route, a vehicle application, and a driver profile; wherein the hybrid powertrain comprises an internal combustion engine, one or more electric power generators, one or more electrically-powered traction motors, and an electrical energy storage device; a vehicle carrying the hybrid powertrain, the internal combustion engine, the one or more electric power generators, the one or more electrically-powered traction motors, the electrical energy storage device, the transmitter, the receiver, and the processing device; means for displaying the information to an operator of the vehicle.

In another aspect of the present application, a system, comprises: a vehicle including a hybrid powertrain and a controller, the hybrid powertrain including an internal combustion engine, one or more electric power generators, one or more electrically-powered traction motors, and an electrical energy storage device, the controller operatively coupled to the hybrid powertrain; a computing device structured to communicate with the controller; wherein the controller is structured to execute operating logic to monitor the hybrid powertrain, to calculate information corresponding to hybrid powertrain energy usage for use in a lease of the vehicle, and to transmit the information to the computing device; and wherein the computing device is structured to receive the information from the controller and to determine a periodic payment for the vehicle as a function of the hybrid powertrain energy usage.

Features of the aspect of the present application may include: means for storing at least one of an amount of fuel saved, a type of hybrid powertrain, a driving route, a vehicle application, and a driver profile; means for displaying the information to an operator of the vehicle; wherein at least one of the generators and at least one of the motors are provided in the form of a motor/generator.

Any experimental (including simulation) results are exemplary only and are not intended to restrict any inventive aspects of the present application. Any theory, mechanism of operation, proof, or finding stated herein is meant to further enhance understanding of the present application and is not intended to make the present application in any way dependent upon such theory, mechanism of operation, proof, or finding. Simulations of the type set forth herein are recognized by those skilled in the art to demonstrate that methods, systems, apparatus, and devices, are suitable for their intended purpose. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any claims that follow are desired to be protected.

What is claimed is:

1. A method, comprising:
providing a vehicle to a customer, the vehicle including a hybrid powertrain operatively coupled to a controller, the hybrid powertrain including an internal combustion engine, one or more electric power generators, one or more electrically-powered traction motors, and an electrical energy storage device;
receiving information corresponding to hybrid powertrain energy usage from the controller; and
varying, as a function of the hybrid powertrain energy usage, an amount of a periodic payment to be made by the customer for the vehicle.

2. The method of claim 1, wherein at least one of the generators and at least one of the motors are provided in the form of a motor/generator.

3. The method of claim 2, wherein the motor/generator is selectively coupled to a mechanical power output shaft of the engine.

4. The method of claim 1, wherein the vehicle includes an alternator.

5. The method of claim 1, wherein the energy storage device includes a plurality of electrochemical cells.

6. The method of claim 1, wherein providing the vehicle to the customer includes leasing the vehicle to the customer.

7. The method of claim 1, wherein the information includes a difference between an amount of fuel used by the hybrid powertrain for a power demand and an amount of fuel that would be used by a non-hybrid engine for the power demand.

8. The method of claim 1, wherein the information includes information regarding energy generated during regenerative braking.

9. The method of claim 1, wherein the information includes information regarding fuel use avoided during idle.

10. The method of claim 1, wherein the information is received by a provider of the vehicle wirelessly from the controller.

11. The method of claim 1, further comprising:
receiving the information during a service event and the information is received by a provider of the vehicle.

12. The method of claim 1, further comprising:
displaying the information in the vehicle to an operator of the vehicle.

13. The method of claim 1, further comprising:
reporting the amount of the periodic payment to the customer.

14. The method of claim 13, wherein reporting the amount of the periodic payment includes at least one of electronically transmitting an invoice to the customer and mailing an invoice to the customer.

15. The method of claim 1, further comprising:
increasing the amount of the periodic payment if actual hybrid powertrain energy usage is less than an expected powertrain energy usage.

16. The method of claim 1, further comprising:
decreasing the amount of the periodic payment if actual hybrid powertrain energy usage is greater than an expected powertrain energy usage.

17. The method of claim 1, further comprising:
increasing a number of payments if actual hybrid powertrain energy usage is less than an expected powertrain energy usage.

18. The method of claim 1, further comprising:
decreasing a number of payments if actual hybrid powertrain energy usage is greater than an expected powertrain energy usage.

19. An apparatus, comprising:
a hybrid powertrain for a vehicle;
a transmitter;
a receiver; and
a processing device operatively coupled to the transmitter, the receiver, and the hybrid powertrain, the processing device being structured to execute operating logic to monitor the hybrid powertrain, to calculate information corresponding to hybrid powertrain energy usage for use in a periodic payment for the vehicle, and to transmit the information to a computing device.

20. The apparatus of claim 19, wherein the processing device transmits the information to the computing device in real-time.

21. The apparatus of claim 19, wherein the computing device is structured to execute operating logic to receive the information corresponding to hybrid powertrain energy usage from the processing device and vary the periodic payment as a function of the hybrid powertrain energy usage.

22. The apparatus of claim 19, further comprising:
means for storing at least one of an amount of fuel saved, a type of hybrid powertrain, a driving route, a vehicle application, and a driver profile.

23. The apparatus of claim 19, wherein the hybrid powertrain comprises an internal combustion engine, one or more electric power generators, one or more electrically-powered traction motors, and an electrical energy storage device.

24. The apparatus of claim 23, further comprising:
a vehicle carrying the hybrid powertrain, the internal combustion engine, the one or more electric power generators, the one or more electrically-powered traction motors, the electrical energy storage device, the transmitter, the receiver, and the processing device.

25. The apparatus of claim 19, further comprising:
means for displaying the information to an operator of the vehicle.

26. A system, comprising:
a vehicle including a hybrid powertrain and a controller, the hybrid powertrain including an internal combustion engine, one or more electric power generators, one or more electrically-powered traction motors, and an electrical energy storage device, the controller operatively coupled to the hybrid powertrain;
a computing device structured to communicate with the controller;
wherein the controller is structured to execute operating logic to monitor the hybrid powertrain, to calculate information corresponding to hybrid powertrain energy usage for use in determining a periodic payment for the vehicle, and to transmit the information to the computing device; and
wherein the computing device is structured to receive the information from the controller and to determine the periodic payment for the vehicle as a function of the hybrid powertrain energy usage.

27. The system of claim 26, further comprising:
means for storing at least one of an amount of fuel saved, a type of hybrid powertrain, a driving route, a vehicle application, and a driver profile.

28. The system of claim 26, further comprising:
means for displaying the information to an operator of the vehicle.

29. The system of claim 26, wherein at least one of the generators and at least one of the motors are provided in the form of a motor/generator.
